(19) United States
(12) Patent Application Publication
(10) Pub. No.: US 2011/0113604 A1
(43) Pub. Date: May 19, 2011

(54) Easy clip carabiner with a retractable trigger

(76) Inventor: Young Chu, (US)

(21) Appl. No.: 12/592,095

(22) Filed: Nov. 18, 2009

(51) Int. Cl. F16B 45/02; A44B 13/02

(52) U.S. Cl. 24/601.5

(57) ABSTRACT

A carabiner has a C-shaped body. At one end of the body, a gate is pivotally mounted and is spring loaded to a closed position. A trigger is attached at the middle of the body with a hook in it, and is also spring loaded to a closed position against the side of the body. When prepared, the trigger will hold the gate open in ready position for easy access. When hit, the trigger will release the gate, springing the gate back to its closed positions. The trigger will also spring back to its closed position, out of the way of the rope moving inside of the carabiner body.

### FIELD OF THE INVENTION

This invention relates to carabiners. More particularly, but not exclusively, it concerns a carabiner used by mountaineers or climbers to ensure their safety with the aid of a rope.

### BACKGROUND OF THE INVENTION

Carabiners generally have a C-shape body with a gate at one end which pivots about an axis. The gate is held by a spring to pivot to its closed position in which the free end engages the other end of the body through a notch in the body and a pin on the gate.

On a mountain climb, in order to secure himself, the climber must quickly attach a loop of rope to the carabiner which is usually held in a closed position by a spring in the carabiner. Climbers often have only one hand available for this maneuver and are in an unstable and dangerous position. If the rope does not clip easily to the closed carabiner, then the climber could be put in danger. Some easy-clip carabiners have designed a trigger for the carabiner that holds the gate open, allowing for the climber to easily clip in. However, when the trigger is hit, the trigger then dangles inside the closed carabiner, damaging the rope and causing unnecessary friction when the rope tangles with the trigger.

The object of the present invention is to provide a carabiner of the type above where the hooking movement of the rope can be simply and rapidly accomplished without problems for the user, and where the trigger retracts, removing the problems of rope damage and unnecessary friction.

### SUMMARY OF INVENTION

The present invention addresses the need for automatic retraction of the trigger on easy-clip carabiner. The normal easy-clip carabiner has a trigger to hold the gate in an open position against the action of a spring, closing automatically when the trigger is hit. But the trigger stays in the way of the rope. Rope can be damaged by the trigger unless the trigger can safely stay away from the rope. This present invention's trigger will also spring back against the sides of the carabiner body or into a notch on the carabiner so as to not damage the rope or to tangle with the rope.

### BRIEF DESCRIPTION OF THE DRAWINGS

FIG. 1 presents three side views of the Easy Clip Carabiner With A Retractable Trigger with a bar trigger. View 1 shows the present invention in closed position. View 2 shows the Easy Clip Carabiner being prepared. View 3 shows the present invention in prepared position for an element to be clipped in.

FIG. 2 presents a view of the different pieces required to construct an Easy Clip Carabiner With A Retractable Trigger.

FIG. 3 presents three views of the Easy Clip Carabiner With A Retractable Trigger that combine to show how the present invention could be used.

FIG. 5 presents three views that combine to show how the Easy Clip Carabiner With A Retractable Trigger with a wire trigger could be used.

FIG. 6 is a view of the different pieces required to construct the present with a wire trigger.

### DESCRIPTION OF PREFERRED EMBODIMENTS

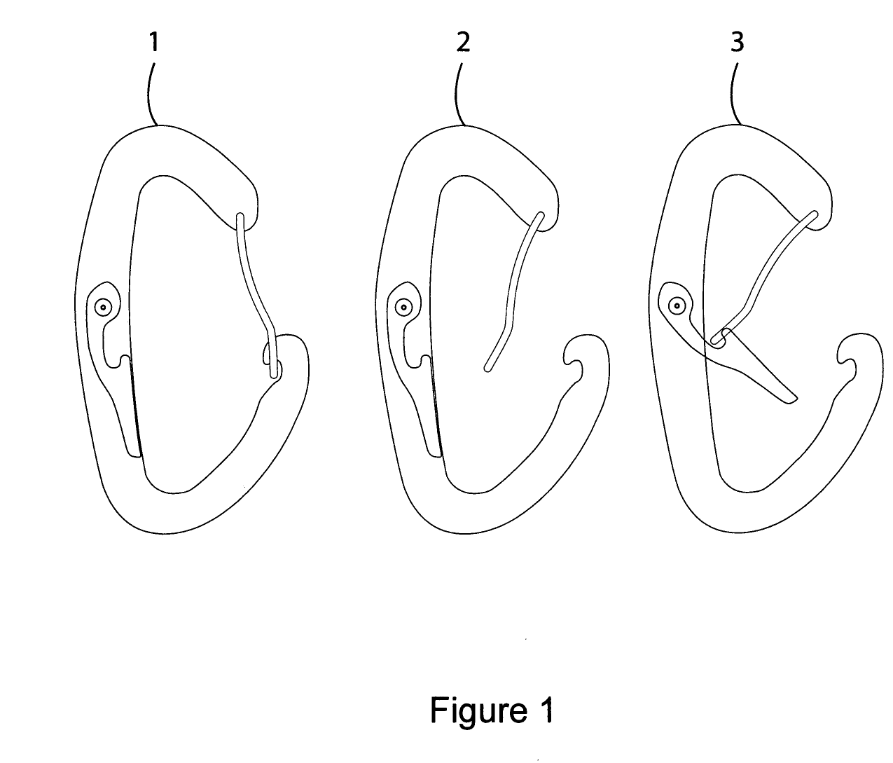

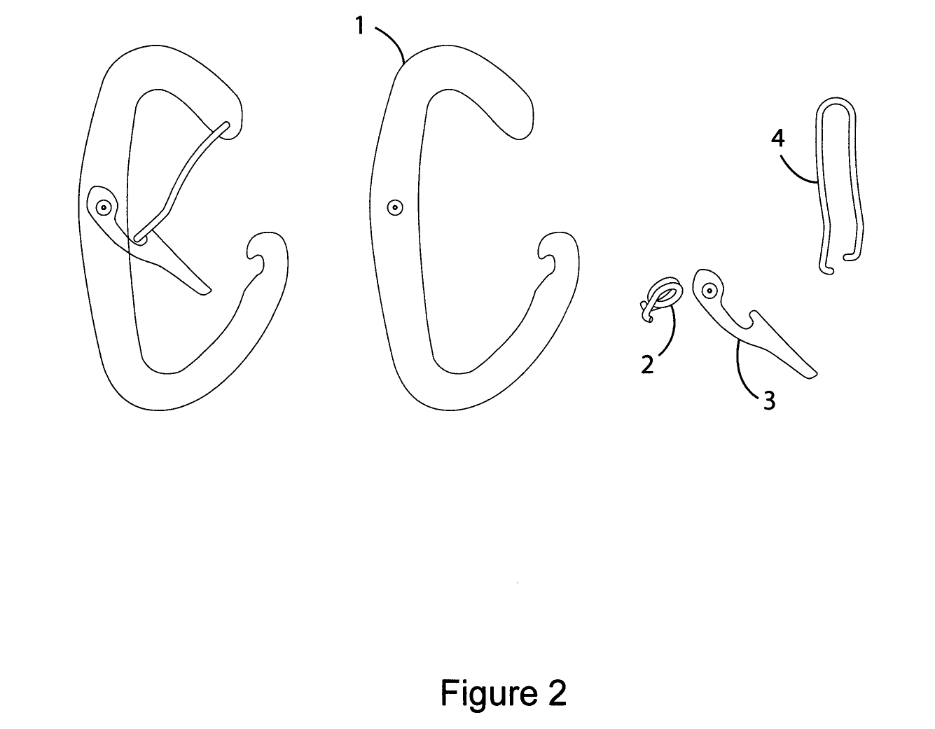

In reference to FIGS. 1-3, the Easy Clip Carabiner With A Retractable Trigger includes a main body 1 which is built in a C-shape. The bar trigger 3 is a strip of metal with a hook in it which is designed to keep the gate 4 open against its spring. The bar trigger 3 itself also has a spring 2 in it so that when the clip is triggered, it will spring back to a rest position along the main body 1, out of inner portion of the body 1. It is attached to the main body through a circular hole and spring mechanism located in the middle of the C-shaped main body 1. The gate 4 is attached to the main body 1 by two holes in the main body 1 on opposite sides of the carabiner in different locations close together on the edge of the main body 1. The placement of these holes provide for the spring action on the gate.

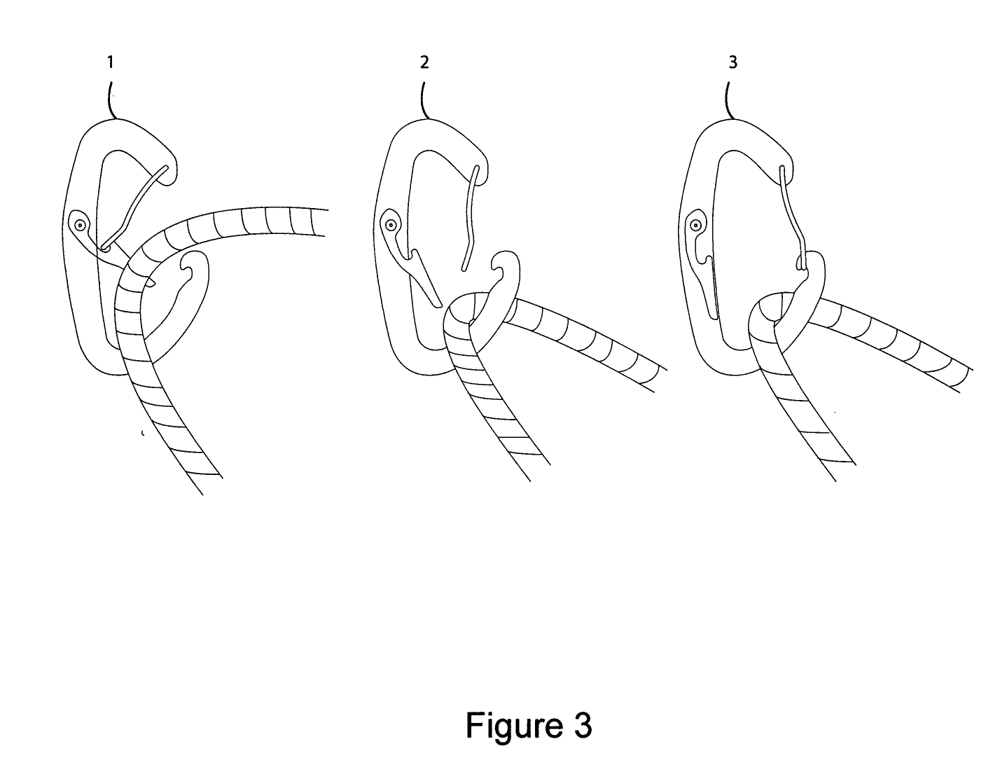

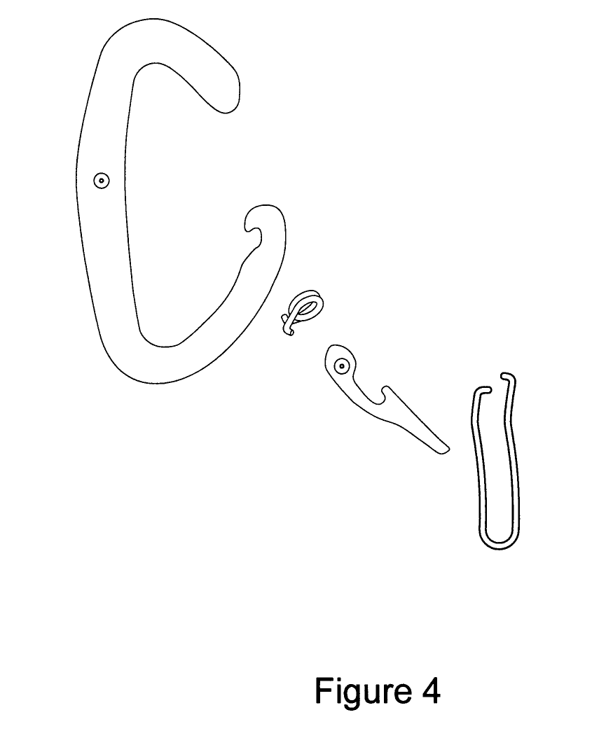

To work the Easy Clip Carabiner With A Retractable Trigger, it must first be set, as demonstrated in FIG. 1. View 1 shows everything in rest position. To set the present invention, a climber must pull the gate 1 back against its spring, and then rest it into the hook on the bar trigger 3. A prepared Easy Clip Carabiner With A Retractable Trigger would be in the position of view 3. This prepared carabiner could be attached to a strap on a rock, and serves as the place where the climber needs to quickly clip into with a rope to secure his position. To do so, the climber would grab a loop of rope and push it into the opening left by the opened gate 4 held by the bar clip 3. The rope hits the bar trigger 3, which releases the gate 4 as shown in FIG. 3. With the spring action in the bar clip 3 and the gate 4, both will spring back to the rest position. The gate 4 will close off the opening in the carabiner, and is secured by the notch at the end of the main body 1. The bar trigger 3 will rest against the side of the main body 1, out of the inner circle of the main body, avoiding contact with the rope.

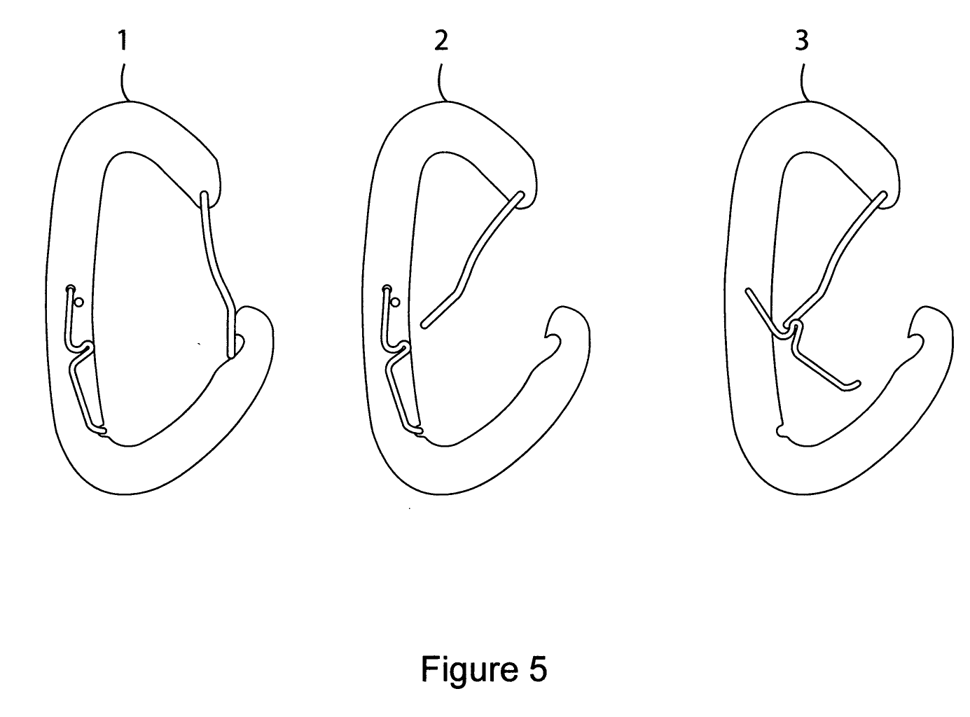

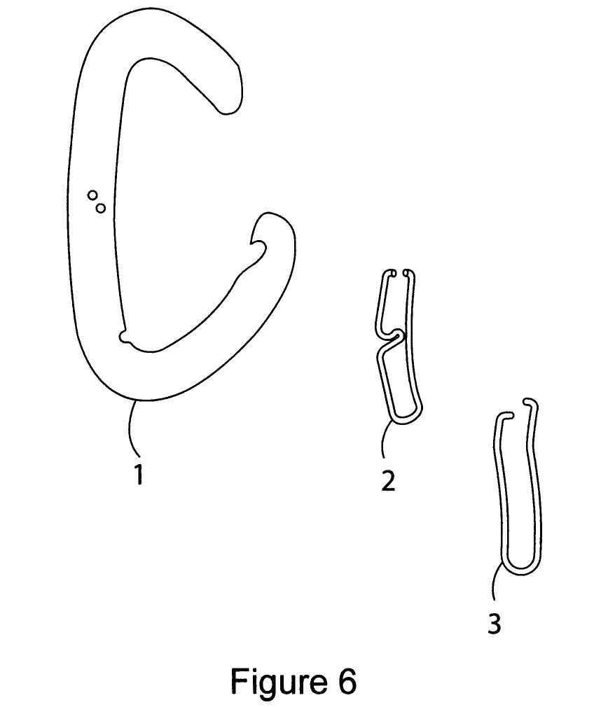

FIGS. 5-6 show an alternative trigger design. Instead of using a bar trigger, this Easy Clip Carabiner With A Retractable Trigger uses a wire trigger 2. The wire trigger 2 consists of a strong wire bent into a U-shape, with a hook along the U portion of the clip. This wire trigger 2 is attached to the main body 1 in the same way as the gate 3—through two holes on opposite sides of the main body 1 in different locations, which provides for the spring action. When triggered by a rope, the wire trigger 2 works in the same way as the bar trigger. The gate 3 will spring back to its closed resting position. The wire trigger 2 will spring back against the main body 1, into a notch build at the base of the curve of the C as shown in FIG. 5, view 1. In that location, the wire trigger 2 will be out of the way of any rope movement inside the carabiner, avoiding rope damage and friction.

What is claimed is:

1. A carabiner comprising a C-shaped body, a springing gate, and a bar trigger to hold the gate open in ready position. The bar trigger will be attached to the body at the middle of the C-shaped body through a hole and a spring inside of the hole, and will consist of a strip of metal with a hook in it. The carabiner will be able to set in a ready position such that the gate is held open by the bar clip. When in ready position, the bar trigger will be easily triggered by an element to be locked into the carabiner, springing the gate back into closed position, securing the element. The trigger will also spring back to its rest position against the side of the main body, outside of the closed C-shaped body, avoiding damage to the rope and unnecessary friction.

2. All of claim 1, except with a wire trigger instead of a bar trigger, and a notch chipped into the base of the C-shaped body to secure the wire trigger. The wire trigger will consist of a wire bent into a U-shape, with a hook along one of the sides of the U.
